(19) United States
(12) Patent Application Publication
(10) Pub. No.: US 2006/0072659 A1
(43) Pub. Date: Apr. 6, 2006

(54) Method for transmitting moving picutres in mobile communication terminal

(75) Inventors: Kang-Wook Kim, Daegu (KR); Jae-Gon Son, Daegu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/207,742

(22) Filed: Aug. 22, 2005

(30) Foreign Application Priority Data
Oct. 1, 2004 (KR) 2004-78467
Jul. 1, 2005 (KR) 2005-59167

(51) Int. Cl. H04N 11/04

(52) U.S. Cl. 375/240.01

(57) ABSTRACT

Disclosed is a method for transmitting moving pictures in a mobile communication terminal. The method comprises the steps of determining if a size of an original moving picture to be transmitted exceeds preset maximum transmission capacity when a user requests transmission of a moving picture, generating a plurality of edited moving pictures by editing the original moving picture when the size of the original moving picture exceeds the preset maximum transmission capacity, and transmitting the edited moving pictures.

### PRIORITY

This application claims to the benefit under 35 U.S.C. §119(a) of applications entitled “Method for Transmitting Moving Pictures by Dividing and Downsampling in Mobile Communication Terminal” and “Method for Transmitting Moving Pictures in Mobile Communication Terminal” filed in the Korean Intellectual Property Office on Oct. 1, 2004 and assigned Serial No. 2004-78467, and on Jul. 1, 2005 and assigned Serial No. 2005-59167, respectively, the entire contents of each being incorporated herein by reference.

### BACKGROUND OF THE INVENTION

1. Field of the Invention

The present invention relates to a method for transmitting a moving pictures or video using a mobile communication terminal. More particularly, the present invention relates to a method for transmitting moving pictures or video using a mobile communication terminal, wherein the moving pictures or video has a data size exceeding a maximum transmission capacity.

2. Description of the Related Art

As digital images are widely used, the requirement for efficient tools capable of processing the digital images is increasing. Such tools include transformation of the image sizes as basic and important image processing tools.

In particular, the transformation of the image size is essentially performed in order to support various image media with single digital image data set. For example, the image media devices required for supporting Video on Demand (VOD) service include liquid crystal display (LCD) devices of portable telephones in addition to typical computer monitors, high definition televisions (HDTVs), and conventional televisions having different sizes. However, it is impossible to prepare and store all of the different digital image data formats suitable for these image media devices. Accordingly, a single digital image data format must be created and stored such that only the size thereof may be transformed according to the image media set.

Generally, the transform of an image size requires the two operations of changing the sampling rate and low pass filtering. In order to reduce an image size, low pass filtering and then downsampling are performed with respect to the image (decimation). In order to increase the image size, upsampling and then low pass filtering are performed with respect to the image (interpolation).

Generally, these operations are performed in a pixel domain. However, most still images and most moving pictures are stored in compressed forms. For this reason, conventionally, in order to transform the size of a compressed image, the three steps of decompressing the compressed image data, transforming the image size, and then re-compressing the image data must be performed. That is, since the three steps of decompressing, transforming the image size, and then re-compressing must be performed in order to transform an image size, a great amount of time is required.

In order to solve the problem, many methods for directly transforming an image size with respect to the compressed image are being developed. Since a compressed image is subject to discrete cosine transform (DCT), transforming the size of the compressed image means transforming the size of the compressed image in a DCT domain.

In the meantime, mobile communication terminals with multimedia functions capable of displaying moving pictures are being developed these days in which an International Mobile Telecommunication-2000 (IMT-2000) technique is being pursued in earnest. The mobile communication terminals with moving picture functions as described above have image sizes larger than those of previous terminals and can support the VOD by employing a color LCD and not a mono color LCD. In addition, the mobile communication terminals allow users to transfer moving pictures via e-mail to other parties by using cameras mounted thereon.

Herein, since the moving pictures must be played regardless of types of the moving picture terminals, standard coders/decoders (CODECs) are used. The most commonly-used standard CODECs include low bit rate compression video CODECs such as the moving picture expert group-1 (MPEG-1), the MPEG-2, the MPEG-4, the H.261, the H.263, and the H.26L.

However, when moving pictures are transmitted through a wireless network, the transmitted moving pictures are restricted to a particular size due to data transmission and reception efficiency and the difficulty of transmitting image data between the mobile communication terminals and the wireless network. For example, when certain mobile communication terminals attempt to transmit moving pictures having a size of above 384 Kbytes, moving picture transmission service is not provided. This is because problems such as data loss and excessive channel use may occur even when moving pictures having a size of above 384 Kbytes are transmitted just once.

Accordingly, when a user intends to transmit moving pictures having a large data size, VOD streaming transmission that is separately passed through the Internet must be achieved. Finally, a new method for efficiently transmitting moving pictures of a large size via a wireless communication terminal and network is required.

### SUMMARY OF THE INVENTION

Accordingly, the present invention has been made to solve the above-mentioned problems occurring in the prior art, and an object of the present invention is to provide a method capable of efficiently transmitting a moving picture or video using a mobile communication terminal even if the moving picture has a data size exceeding a maximum transmission capacity.

To accomplish the above objects, there is provided a method for transmitting a moving picture in a mobile communication terminal, the method comprising the steps of determining if a size of an original moving picture to be transmitted exceeds a preset maximum transmission capacity when a user requests transmission of a moving picture, generating a plurality of edited moving pictures by editing the original moving picture when the size of the original moving picture exceeds the preset maximum transmission capacity, and transmitting the edited moving pictures.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart showing a method for transmitting a moving picture in a mobile communication terminal according to an embodiment of the present invention;

FIG. 2 is a flowchart showing a procedure for creating moving pictures by editing original moving pictures through the operation procedure shown in FIG. 1; and

FIG. 3 is a block diagram showing a functional unit performing the variable length decoding in the operation procedure shown in FIG. 2.

Throughout the drawings, it should be understood that like reference numbers refer to like structures, features and elements.

### DETAILED DESCRIPTION OF THE EXEMPLARY EMBODIMENTS

Hereinafter, an exemplary embodiment of the present invention will be described in detail with reference to the accompanying drawings. In the following description of an embodiment of the present invention, a detailed description of known functions and configurations incorporated herein will be omitted for the sake of conciseness.

Hereinafter, according to one embodiment of the present invention, the MPEG-4 video compression scheme will be described by way of example. Therefore, various video compression schemes can be employed in addition to the MPEG-4 video compression.

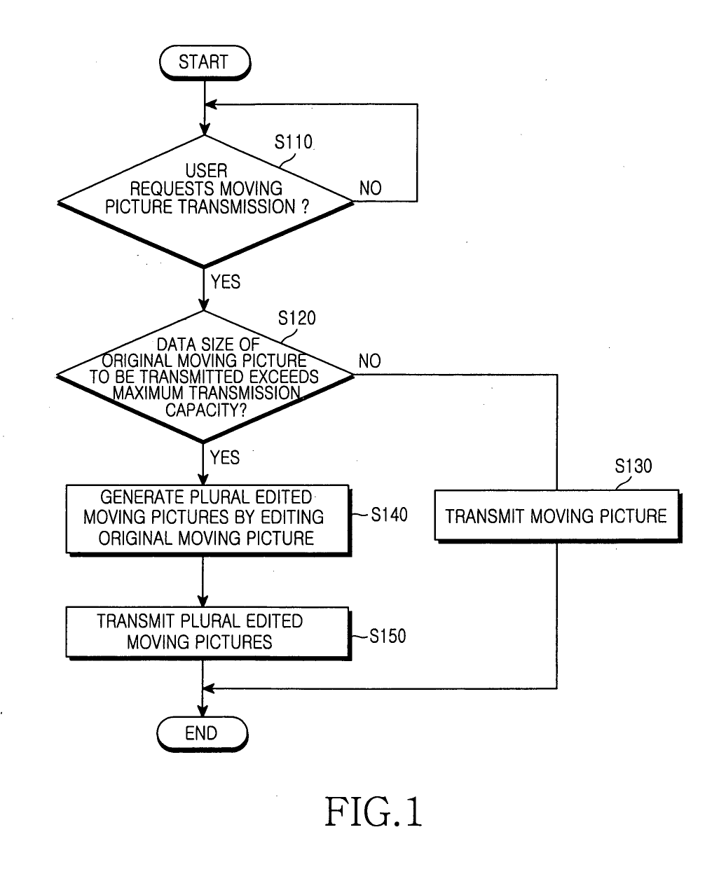

FIG. 1 is a flowchart showing a procedure of transmitting a moving picture of a mobile communication terminal according to one embodiment of the present invention.

The mobile communication terminal determines if a user requests transmission of a predetermined moving picture (step S110). The user's request may include a video mail transmission request.

If the user has requested the transmission of the moving picture, the mobile communication terminal determines if data size of the original moving picture to be transmitted exceeds the preset maximum transmission capacity (e.g., 384 Kbyte) (step S120). The maximum transmission capacity implies the transmittable data capacity, which can be transmitted at a time in the mobile communication terminal through a wireless network. In addition, the maximum transmission capacity refers to the maximum data transmission capacity determined by each terminal manufacturing company in consideration of a wireless network state, a transmission efficiency, and a mobile communication terminal transmission capacity. For example, in certain mobile communication terminals, the maximum data transmission capacity is currently set to 384 Kbytes.

If the data size of the original moving picture does not exceed the preset maximum transmission capacity (384 Kbytes, for example), the mobile communication terminal may transmit the corresponding moving picture through the wireless network (step S130).

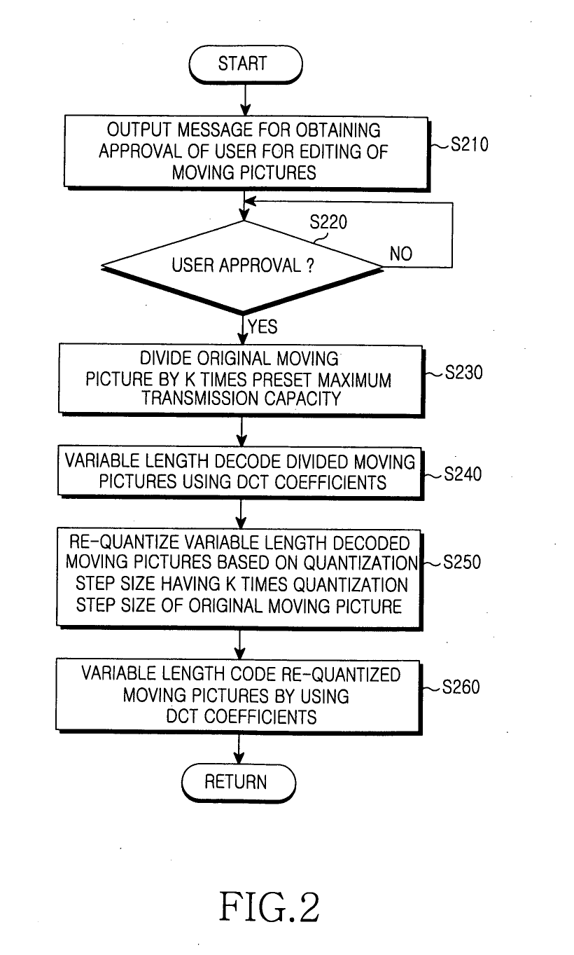

If the data size of the original moving picture to be transmitted exceeds the preset maximum data transmission capacity, the mobile communication terminal generates a plurality of edited moving pictures by editing the original moving picture (step S140). The edited moving pictures refer to data obtained by bit-rate downsampling the original moving picture, which has been divided into several moving pictures having a predetermined size. A more detailed description of the step of editing divided moving pictures will be given later with reference to FIG. 2.

The mobile communication terminal sequentially transmits the edited moving pictures (step S150).

Hereinafter, step S140 will be described further in more detail.

FIG. 2 is a flowchart illustrating in detail step 140 of editing moving pictures in the operation procedure shown in FIG. 1.

If the data size of the original moving picture to be transmitted exceeds the maximum transmission data capacity, the mobile communication terminal outputs a message for obtaining approval of the user for the editing of the moving pictures (step S210). The message may include a voice message and a character message.

The mobile communication terminal determines if there is a user's approval for the output message (step S220).

Hereinafter, for the purpose of the description, a moving picture having the size of 30 Mbytes photographed at a bit rate of 384 kbps will be described by way of example.

If there is the approval the user, who has preferably checked the message, the mobile communication terminal divides the original moving picture by K times the preset maximum transmission capacity (step S230). Herein, the magnifying power of K is identically employed in the next re-quantization step. In detail, the reference to the re-quantization step size in the re-quantization step is determined by enlarging a previous quantization step size by K times.

Accordingly, when the moving picture having the size of 30 Mbyte is divided, the moving picture is divided by about 1 Mbytes (about three times the 384 Kbytes). In other words, K is equal to 3.

For example, in the MPEG-4 video compression, the division by the size of 1 Mbytes in step S230 may be achieved by analyzing and cutting an Atom header on the basis of an I-frame.

If the moving picture has been processed through the division step, a total of 30 moving pictures can be generated by dividing 30 Mbytes by 1 Mbyte.

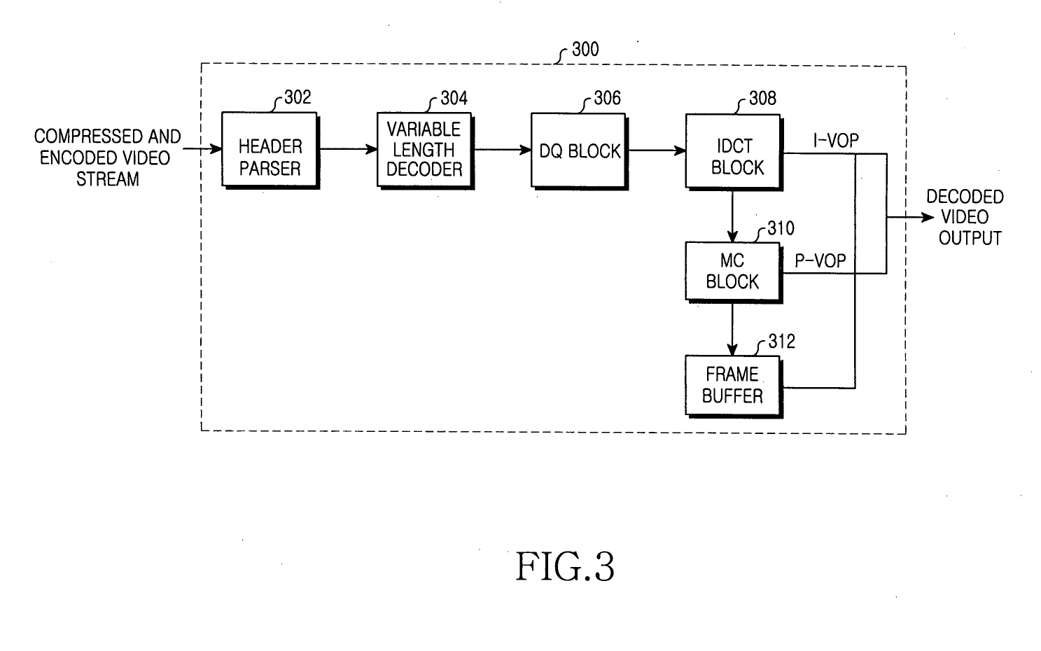

The mobile communication terminal performs variable length decoding (VLD) with respect to the divided moving pictures using the DCT coefficients (step S240). A more detailed description of the VLD will be given later with reference to FIG. 3.

The mobile communication terminal re-quantizes the variable length decoded moving pictures based on a quantization step size, which is K times a quantization step size of the original moving picture (step S250). In other words, the mobile communication terminal re-quantizes the variable length decoded moving pictures by employing a predetermined quantization step size, which is K times the previous quantization step size.

The mobile communication terminal performs variable length coding (VLC) with respect to the re-quantized moving pictures by using DCT coefficients (step S260).

Through the above steps, when 30 moving pictures having a size of 1 Mbyte are quantized in three times the previous quantization step size as described above, the 30 moving pictures become edited moving pictures each having a size of 384 Kbytes with a bit rate of 128 kbps through the VLC step (step S260) and the re-quantization step (step S250) in a 3×quantization step size (QP).

Accordingly, through the above steps, the mobile communication terminal generates 30 edited moving pictures each having a size of 384 Kbytes with a bit rate of 128 kbps using an original moving picture having a size of 30 Mbytes with a bit rate of 384 kbps and transmits the 30 moving pictures via the wireless network through 30 occurrences of a moving picture transmission.

In the meantime, the VLC may be realized through a variety of the conventional schemes.

In detail, video compression encoding techniques such as the MPEG-1, the MPEG-2, the MPEG-4, the H.261, the H.263, and the H.26L remove spatial redundancy by using a characteristic in which the energy of a two-dimensional image is centralized in low frequency terms (typically, direct current coefficients) after the discrete cosine transform (DCT) based on an orthogonal relationship between a spatial domain and a frequency domain. The large values decrease through the quantization after the DCT, and the small values converge to the value of zero, so that the image compression through the VLC may be achieved.

Since the VLC may be realized through the conventional VLC schemes such as U.S. Pat. No 5,708,732 (Fast DCT domain downsampling and inverse motion compensation) embodying 1/n downsampling by creating one 8×8 DCT block which is an average of n 8×8 DCT blocks and U.S. Pat. No. 5,845,015 (Method and apparatus for resizing images using the discrete cosine transform) performing a low pass filtering by multiplying the DCT coefficients by transform coefficients of a low pass filter and then creating a 4×4 DCT block by performing a folding over operation and a subtraction operation with respect to filtered coefficients, a detailed description of VLC will be omitted. The entire contents of both U.S. Pat. Nos. 5,708,732 and 5,845,015 are incorporated herein by reference.

FIG. 3 is a block diagram showing a functional unit performing the variable length decoding in the operation procedure shown in FIG. 2. In other words, step S240 of FIG. 2 in which the mobile communication terminal performs variable length decoding with respect to each of divided moving pictures using DCT coefficients will be briefly described with reference to FIG. 3.

A compression video decoder 300 shown in FIG. 3 comprises a header parser 302, a variable length decoder 304, a DQ (de-quantization) block 306, an inverse discrete cosine transform (IDCT) block 308, an MC block 310, and a frame buffer 312 so as to decode a compressed and encoded video stream into an original image before the compression and the encoding.

It is assumed that a compressed and encoded video stream input to the compression video decoder 300 shown in FIG. 3 denotes a video stream compressed and encoded in the form of an MPEG 4 simple profile employing the DCT.

Various information according to the encoding in the compressed and encoded video stream is analyzed by the header parser 302, the compressed and encoded video stream is decoded by the variable length decoder 304, and then, de-quantized by the DQ block 306, and then applied to the IDCT block 308.

Herein, the IDCT block 308 performs IDCT with respect to the de-quantized video streams, such as 8×8 block DCT images. An image obtained by decoding I-VOP is output as an output image and is stored in a frame buffer 312 and P-VOP is applied to the motion compensation (MC) block 310.

Herein, the I-VOP denotes an image obtained by encoding the entire image, and the P-VOP denotes a differential image representing only a difference between a current image and a previous image without temporal redundancy.

The MC block 310 of the compression video decoder 300 decodes this P-VOP and then reproduces an image by synthesizing the P-VOP with a reference image. That is, the image is reconstructed by reading a reference block after movement from the previous image according to a motion vector.

Accordingly, the MC block 310 decodes and outputs an image according to the P-VOP by performing MC processing based on the I-VOP and the P-VOP.

As described above, according to an embodiment of the present invention, since a moving picture having a great size can be divided, downsampled, and then transmitted, the moving picture can be wirelessly transmitted regardless of the size thereof in a mobile communication terminal. In addition, embodiments of the present invention propose an algorithm for downsampling the divided moving pictures, so that it is easy to realize the downsampling of the moving pictures in the mobile communication terminal.

While the invention has been shown and described with reference to certain exemplary embodiments thereof such as a portable terminal, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A method for transmitting a moving picture in a mobile communication terminal, the method comprising the steps of:
determining if a size of an original moving picture to be transmitted exceeds a preset maximum transmission capacity when a user requests transmission of a moving picture;
generating a plurality of edited moving pictures by editing the original moving picture when the size of the original moving picture exceeds the preset maximum transmission capacity; and
transmitting the edited moving pictures.

2. The method as claimed in claim 1, wherein the edited moving pictures are data obtained by bit-rate downsampling the original moving picture, which have been divided into several moving pictures having a predetermined size.

3. The method as claimed in claim 1, wherein the step of generating the edited moving pictures comprises the steps of:
outputting a message for obtaining approval of the user for editing of the moving picture when the size of the original moving picture exceeds the preset maximum transmission capacity; and
generating the edited moving pictures by dividing the original moving picture by a predetermined size and then performing bit-rate downsampling when the user approves the editing of the original moving picture.

4. The method as claimed in claim 3, wherein the step of generating the moving pictures comprises the steps of:
dividing the original moving picture by a value corresponding to K times the preset maximum transmission capacity;
performing variable length decoding for each divided moving picture using discrete cosine transform coefficients;
re-quantizing each variable length decoded moving picture based on a quantization step size having K times a quantization step size of the original moving picture; and
performing variable length coding for each re-quantized moving picture using discrete cosine coefficients.

5. The method as claimed in claim 4, wherein a value of K used in the dividing step is identical to a value of K used in the re-quantizing step.

6. The method as claimed in claim 1, wherein, in the step of transmitting the edited moving pictures, the edited moving pictures are transmitted through a wireless network.
